(19) United States
(12) Patent Application Publication
(10) Pub. No.: US 2015/0053339 A1
(43) Pub. Date: Feb. 26, 2015

(54) HIGH TEMPERATURE LABEL COMPOSITES AND METHODS OF LABELING HIGH TEMPERATURE MATERIALS

(71) Applicant: FLEXcon Company, Inc., Spencer, MA (US)

(72) Inventors: Ronald Ducharme, Dudley, MA (US); Kenneth Koldan, Rockford, IL (US); Richard T. Skov, Spencer, MA (US)

(21) Appl. No.: 14/467,457

(22) Filed: Aug. 25, 2014

Related U.S. Application Data
(60) Provisional application No. 61/869,233, filed on Aug. 23, 2013.

(51) Int. Cl. G09F 3/10; B65C 9/00; B65C 1/02

(52) U.S. Cl. CPC G09F 3/10; B65C 1/02; B65C 9/0006
USPC 156/247; 428/354; 428/41.8; 428/334; 428/335; 428/332; 156/60

(57) ABSTRACT

The invention provides a label composite that includes a print receptive layer, an intermediate extensible layer, a structural layer, and a primary adhesive. The print receptive layer is adapted to withstand temperatures up to 1200° F. (649° C.) without loss of any of readability, cracking, peeling or edge lifting. The intermediate extensible adhesive layer is provided on one side of the print receptive layer, and the intermediate extensible adhesive layer is capable of surviving temperatures up to 1200° F. The structural layer is adhered on a first side of the structural layer to the intermediate extensible adhesive layer, and the structural layer is adapted to withstand temperatures up to 1200° F. The primary adhesive layer is capable of surviving temperatures up to 1200° F. and is adapted to form a bond between an elevated temperature material and the structural layer of the label composite.

### PRIORITY

The present application claims priority to U.S. Provisional Patent Application Ser. No. 61/869,233 filed Aug. 23, 2013, the disclosure of which is hereby incorporated by reference in its entirety.

### BACKGROUND

The invention generally relates to labels and labeling, and relates in particular to the labeling of products prior to cooling where the products are manufactured at high temperatures.

The labeling of products as the products are manufactured is essential in many industries for purposes of inventory control and asset management. If manufactured product is not labeled immediately following production, the identity of the product and details regarding its manufacture may be lost, particularly during high volume production or high value production. The sooner an item is labeled with regard to its type, grade, lot or batch, date of manufacturer, etc. the less likely that a misidentification of the item will occur. The misidentification of inventory materials may lead to serious consequences, such as increased waste in raw materials, the potential for product failures if inadequate product is mislabeled, damage to high value manufacturing equipment, lost revenue due to line down contract penalties, and the potential for product failures. Inventory labeling immediately following manufacture has therefore become an integral part of business today, in maintaining proper quality traceability and inventory expenses.

One area where there has been a problem in labeling of a freshly manufactured material or a material with some subsequent processes, is when the primary or secondary process involves elevated temperatures. For example, a newly formed steel alloy should have an identifying label applied to it as soon after it is formed as possible since waiting for the coil to cool down prior to labeling risks having it incorrectly identified. Similarly, when the manufacturing process involves a secondary heat process such as annealing, the application of a label as soon as possible after the secondary processing step is desired.

Current high temperature labels (or tags) consist of a pre-printed or otherwise inscribed plate made of ceramic or metal that is mechanically fastened to the hot object to be labeled. This may require that rivets or other fastening devices be set into the product, potentially damaging a portion of the product. This may also be unsafe for the personnel that whose job it is to apply the label to the hot product.

There remains a need therefore, for a label substrate for, and for a method of, labeling of products at elevated temperatures.

### SUMMARY

In accordance with certain embodiments, the present invention provides a label composite that includes a print receptive layer that is adapted to withstand temperatures up to 1200° F. (649° C.) without loss of any of readability, cracking, peeling or edge lifting, an intermediate extensible adhesive layer on one side of the print receptive layer, wherein the intermediate extensible adhesive layer is capable of surviving temperatures up to 1200° F., a structural layer adhered on a first side of the structural layer to the intermediate extensible adhesive layer, wherein the structural layer is adapted to withstand temperatures up to 1200° F., and a primary adhesive layer that is capable of surviving temperatures up to 1200° F. and being adapted to form a bond between an elevated temperature material and the structural layer of the label composite.

In accordance with another embodiment, the invention provides a label composite that includes a print receptive layer that includes an inorganic pigment material with a silicone binder, wherein the inorganic pigment material has a pigment to binder ration of between about 1/1 and 4/1, an intermediate extensible adhesive layer on one side of the print receptive layer, wherein the intermediate extensible adhesive layer includes silicone, a structural layer adhered on a first side thereof to the intermediate extensible adhesive layer, and a primary adhesive layer being adapted to form a bond between an elevated temperature material and the structural layer of the label composite.

In accordance with a further embodiment, the invention provides a method of providing a label for on an elevated temperature material, wherein the method includes the steps of providing a print receptive layer that is adapted to withstand temperatures up to 1200° F. (649° C.) without loss of any of readability, cracking, peeling or edge lifting on a structural layer that is adhered to the print receptive layer by an intermediate extensible adhesive layer, wherein the intermediate extensible adhesive layer is capable of surviving temperatures up to 1200° F., and wherein the structural layer is adapted to withstand temperatures up to 1200° F.; adhering the structural layer to an elevated temperature material using a primary adhesive layer that capable of surviving temperatures up to 1200° F. and that is adapted to form a bond between the elevated temperature material and the structural layer; and permitting the print receptive layer to move with respect to the structural layer over an operating temperature range following application to the elevated temperature composite.

### BRIEF DESCRIPTION OF THE DRAWINGS

The following description may be further understood with reference to the accompanying drawings in which:

FIGS. 1A and 1B show composites for use in labelling high temperature materials in accordance with various applications in which the invention may be employed;

FIGS. 2A-2C show composites for use in labelling high temperature materials in accordance with further applications in which the invention may be employed; and

FIGS. 3A-3C show composites for use in labelling high temperature materials in accordance with further embodiments of the invention.

The drawings are shown for illustrative purposes only and are not to scale.

### DETAILED DESCRIPTION

It has been discovered that by using a polysiloxane based polymer blended with a silicate-like MQ resin, as the binder and a TiO₂/silicate combination as the pigment, a stable, print receptive coating may be achieved. Further when this coating is applied to a high temperature (e.g., up to 732° C.) substrate, such as an aluminum or copper or other metallic foil or screen or mesh, a print receptive, chemically and dimensionally stable label material may be provided.

Such a label composite should be able to survive high temperature, e.g., 800° F.-1350° F. (427° C.-732° C.), exposures. Further the label composite should be in some fashion inscribable, and further the indicia place on the label composite must itself survive the elevated temperatures. Further desirable properties in such a label composite may include:
1—The label composite could conform to non-flat surfaces, for example inside (or outside) of a pipe or if necessary compound curves.
2—The conformability of the label composite should not be so conformable as to fold over on itself during application.
3—The label composite should bond to the hot substrate quickly and maintain a good bond as the elevated temperature (hot) material goes through the cooling down process.

It is known that high temperature resistant polymers such as polyimides have chemical and dimensional stability problems at temperatures over 500° C. (932° F.), relating to a polymeric degradation and destructive differential thermal expansion between the components of a label composition. The present invention is therefore directed to the combination of materials that may be printable, thermally stable, have some degree of thermal expansion compensation and may be easily adhered to a hot substrate while surprisingly achieving the objectives described herein.

To adhere a label material to a hot (e.g., 427° C.-732° C.) surface, a pressure sensitive silicone adhesive may be employed that is specifically formulated to develop adhesion and maintain adhesion when placed in contact with a hot surface. To achieve higher temperatures, (e.g., over 1000° F. (538° C.)) the use of metal foils as the substrate material is preferred as they would offer a good degree of protection of the adhesive layer from oxygen at the elevated temperature.

For items that are processed at elevated temperature and remain at an elevated temperature when labeled, (e.g., up to about 1350° F. (˜732° C.)), the label material itself must be able to survive those conditions. Survival means establishing a bond to, and staying on, the hot material, and remaining readable for a time at least until the material is incorporated in some other composite, or in some cases for the total useful life of the material. It is also preferred that the label employ a self-adhering adhesive. The label material should also be able to accept markings and the markings must be able to remain readable after exposure to elevated temperatures.

Another objective is that the label material should be conformable enough to adhere to non-flat surfaces; substrates such as metal or ceramic tend to be less flexible, making conformability problematic. A further objective relates to the effects of differential thermal expansion and contraction. If the label is not held in place securely or does not remain in full contact to the surface of the product to be labeled, differential thermal expansion may cause distortions of the label, which may affect the ability to read the information on the label or the ability to print information onto the label composite after the label composite is applied to a hot material.

It is an object of the present invention therefore to provide a label material that may survive elevated thermal conditions, and is conformable enough to make contact with and maintain a bond with a non-flat surfaces, yet is resistant to folding over onto itself during application of the label and that has an extensible layer or layers to help compensate for the differential thermal expansion, so as to resist label curling, chipping or distorting.

In accordance with certain embodiments, therefore, the label composite may include a print receptive layer that is adapted to withstand temperatures up to 1200° F. (649° C.) without loss of any of readability, cracking, peeling or edge lifting, an intermediate extensible adhesive layer on one side of the print receptive layer, wherein the intermediate extensible adhesive layer is capable of surviving temperatures up to 1200° F., a structural layer adhered on a first side of the structural layer to the intermediate extensible adhesive layer, wherein the structural layer is adapted to withstand temperatures up to 1200° F., and a primary adhesive layer that is capable of surviving temperatures up to 1200° F. and being adapted to form a bond between an elevated temperature material and the structural layer of the label composite.

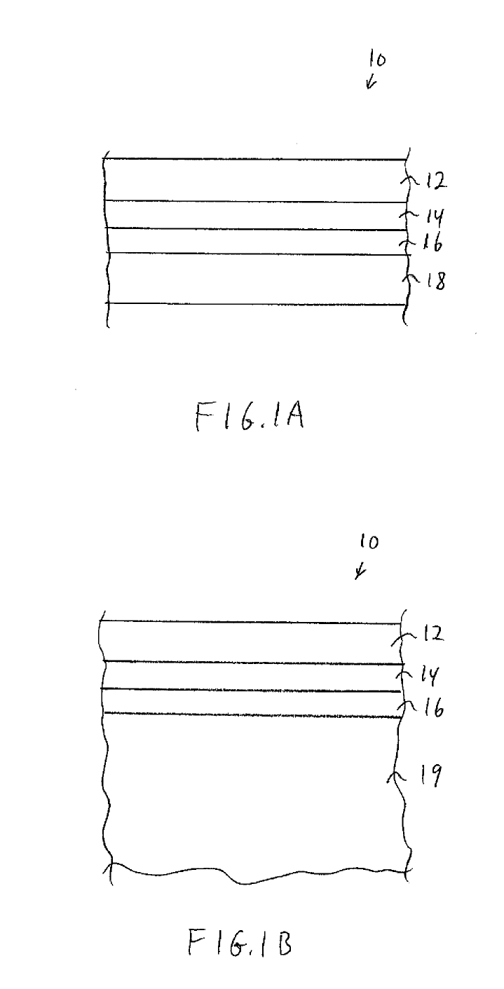

With reference to FIG. 1A, in accordance with an embodiment the invention provides a label composite 10 that includes a print receptive layer 12, a structural layer 14, an adhesive layer 16 and a release liner 18. The print receptive layer 12 is formed, for example of silicone adhesive, and is able to accept various markings, is able to withstand the application high temperatures, and is able to compensate for differential thermal expansion of the label material as well as the substrate being labeled. In particular, in an example, the print receptive layer may be formed of a polysiloxane based polymer blended with a silicate-like MQ resin, as the binder, and a TiO₂/silicate combination material may be used as the pigment for the printing. The print receptive layer may, for example, in certain embodiments be printable by a laser, or may provide a surface on which printing may be applied.

As shown in FIG. 1B, during application to a substrate, the release liner 18 is removed, and the exposed pressure sensitive adhesive 16 is then applied to the hot surface of the product 19 to be labeled.

The structural layer 14 may be formed of materials such as metallic foils, metallic scrims, or non-metallic materials such as carbon fiber scrims, fiberglass and ceramics. An important function of the structural layer 14 is to balance the combination of stiffness to conformability. The label composite should have sufficient stiffness so as to not fold over on itself during the application of the label composite to the hot material being labeled, but be flexible enough to follow substrate curvatures. Features such as stiffness and conformability may be varied within the scope of the present invention. The assessment of stiffness values was done on a Handle-O-Meter (Thwing-Albert Model 211-5). Stiffness values between about 50 grams and about 500 grams are preferred, and between about 100 grams and about 200 grams are more preferred.

The adhesive layer 16 may be formed of a pressure sensitive adhesive (PSA), and should be able to form a bond quickly enough so that the label composite does not have to be held on the hot surface for an extended (e.g., greater than 5 seconds) period of time. The adhesive should also maintain adhesion after application and still compensate for some differential thermal expansion and cooling contraction between the label and the surface of the product being labeled.

In accordance with further embodiments, an intermediate extensible adhesive layer such as a high temperature silicone based adhesive, may be provided between the print receptive layer 12 and the structural layer 14. The high temperature silicone based adhesive may, for example, be a DENSIL (SA-9000) silicone adhesive sold by FLEXcon Company, Inc. of Spencer, Mass. or a FLEXcon's EXV-495 silicone adhesive sold by FLEXcon Company, Inc. of Spencer, Mass.

To address these issues for the print receptive layer, a silicone adhesive was employed as the binder in the coating. Silicones have the advantage that even upon heavy pigment additions (e.g., with pigment to binder ratios as high as 4/1), the elastomeric properties are still sufficient to allow for some expansion and subsequent contraction without cracking, chipping or curling. The pigment, a blend of silica (Cabosil M5,) may be obtained from the Cabot Corporation of Boston, Mass., and TiO₂ (TiONA RCL-9 pigment) may be obtained from Crystal Metals, of Woodridge, Ill. The pigment blend (TiO₂/Silica) may be from about 12/1 to about 30/1, and preferably is between about 16/1 to about 24/1.

The silicone adhesive used in the binder, was prepared from Silgrip 6573A silicone adhesive sold by Momentive Performance Materials, Inc. of Albany, N.Y., whose Silgrip 6574 silicone adhesive was also found to work. The binder was cured with an organo-peroxide such as Perkadox L-W75, (sold by AkzoNobel Polymer Chemicals LLC, of Chicago, Ill.) in a range of about 0.25-3.0 wt. % based on the solids of Silgrip 6573A, and preferable in a range of about 0.5-1.0 wt. %. Other suitable curing agents may be found in the product literature on Silgrip 6573A. The ratio of pigment (TiO₂ and Silica) to binder (cured Silgrip 6573A) may range between about 1/1 to about 4/1, and more preferably may range from about 1.4/1 to about 2/1.

In certain applications, the binder may left uncured, but in order to maintain internal resistance to excessive flow, the higher pigment-to-binder ratios approaching 4/1 may be used. In cases where additional stability for extended exposure time at elevated temperature is required, such as during an annealing process, anti-oxidants may be used. In this circumstance, one may also choose not to use a radical initiator to cure the silicone. In such cases, the higher binder levels (4/1) may be an alternative way to maintain dimensional stability in the printable coating.

The print receptive layer 12 may be marked by a thermal transfer printer such as the ZT200 printer from Zebra Technologies, Lincolnshire, Ill., with the ITW HT1200 thermal transfer ribbon product from ITW Thermal Films USA, of Romeo Mich. The coating was found to be printable by a laser, for example using a S-Series Plus Model S-200+Black CO₂ laser sold by Domino Laser, Inc. of Anaheim, Calif. has been found to permanently mark the printable layer of the label composite.

The structural layer may be formed of an aluminum foil from 0.5 mil-about 20 mil (about 13-about 500 microns) and is preferably between about 1 mil-about 10 mil (25-250 microns) and more preferably between about 2 mil-about 5 mil (50-125 microns). Such foils are available from All Foils Inc. of Minneapolis Minn. Copper and other metallic and non-metallic structural layers may also be employed in certain embodiments, e.g., when the expected temperature exceeds certain limits. Aluminum, for example, melts at about 1200° F. and thus would present problems in applications over 1200° F.

The primary adhesive layer 18 should form a bond and hold the label on the high temperature material. The adhesive also needs good initial adhesion and shear properties. The adhesive deposition may range between about 0.5 mil (0.13 microns) for flat smooth surfaces to about 10 mil (250 microns) for rough textured and curved surfaces, although most application may be handled with an adhesive thickness of about 1.0 mil (25 microns)-about 4 mil (100 microns). An adhesive that meets these requirements is the FLEXcon EXA-495 pressure sensitive silicone adhesive sold by FLEXcon Company, Inc. of Spencer, Mass.

### Example 1

In a first example, a printable layer was provided that included the following:

| | Weight % (Wet) |
|---|---|
| Silgrip 6573A | 37.45 |
| Toluene | 20.4 |
| Ti-Pure R-900 | 40.0 |
| Cabosil M5 | 1.85 |
| Perkadox L-W75 | 0.30 |

The composite was dried and cured on the first side of a 5 mil aluminum foil, to a dry coating deposition of 1.2 mil (30 microns). On the second side of the aluminum was placed 2 mil (50 microns) of FLEXcon's EXA-495 with a release liner.

In accordance with another embodiment of the invention, the printable coating is first applied to a releasable casting substrate, dried, and cured. To the printable coating side an adhesive layer such as FLEXcon's EXA-495 or other such adhesives is applied to 0.5-5.0 mil (13-125 microns), and the deposition is dried and cured; a preferable deposition range is between 1-2 mil. A removable liner is then placed over this adhesive layer. This composite may then have the liner on the adhesive side removed and the composite is then laminated to the supporting structure layer by the adhesive side to the first side of the supporting structure. To this intermediate composite, the bonding adhesive layer (FLEXcon's EXA 495), with its release liner, is applied to the second side of the structural layer (adhesive to structural layer). Prior to use the releasable casting substrate is removed.

### Example 2

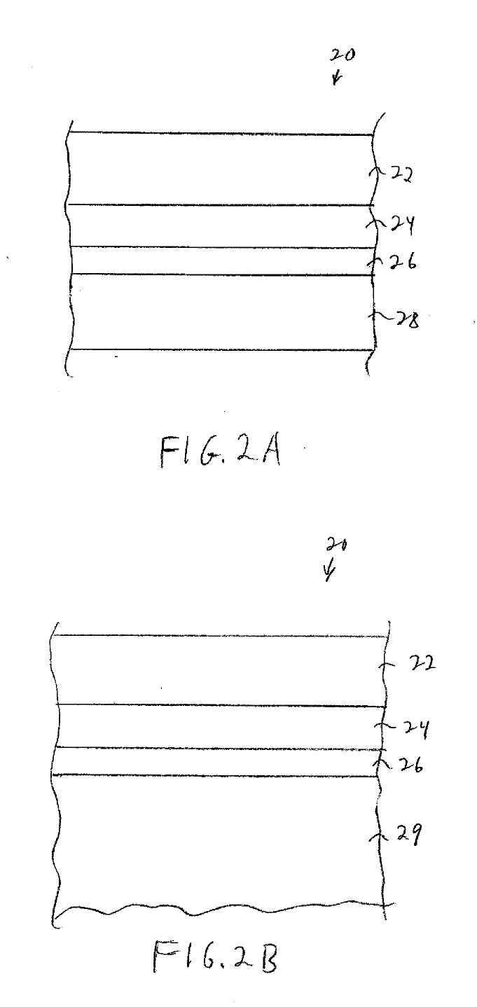

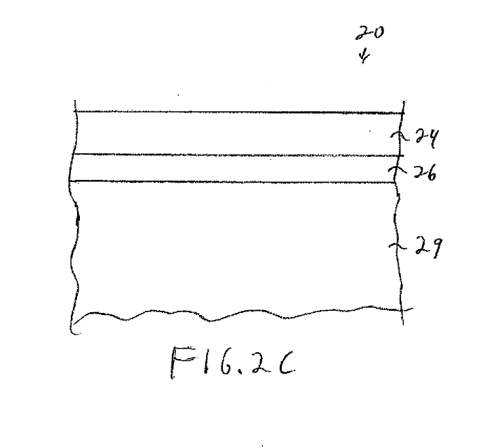

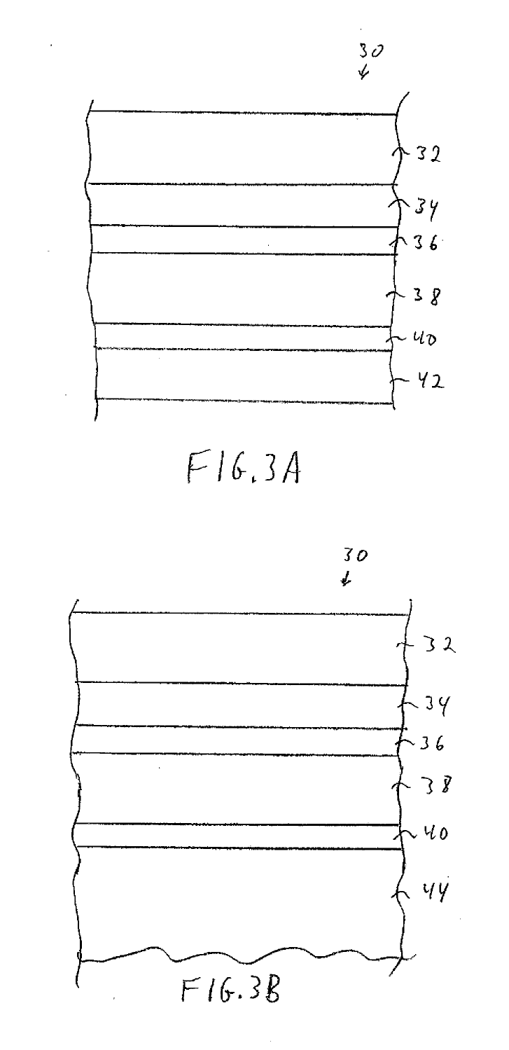

In a second example the printable coating (at about 1.2 mil (30 microns)) is cast on a releasable carrier that is dried at 200° F. for about 2 min., and cured at 320° F. for an additional 2 min. The cured printable coating was then laminated to 1 mil (25 microns) EXA-495 adhesive with a release liner. This is shown at 20 in FIG. 2A with the releasable carrier (casting material) shown at 22, the printable coating shown at 24, the adhesive shown at 26 and the release liner shown at 28.

The composite 20 may then be laminated to a supporting structure as shown in FIGS. 2B and 2C. In particular, the release liner 26 is removed and the composite 20 is applied to the product 29 as shown in FIG. 2B. An advantage of this method of making the final composite is the ability to change supporting substrates to better able to meet a specific application's requirements, such as carbon fiber (available from TPF America, Schenectady, N.Y.), or fiber glass fabrics (available from Nanjing TongTian & Technology Industrial Co., Ltd., Jiangsu Province, China), or metallic screen material.

The releasable carrier 22 is then removed, leaving only the adhesive layer 26 and the print receptive layer 24 on the product 29. The EXA-495 or other thermally stable adhesives are then provided as having been laminated to one side of a supporting substrate opposite from the printable coating side. Typically this adhesive layer may be provided at a thickness of about 0.5 mil-about 4 mil (13-100 microns), with the deposition preferably between about 1 mil and about 3 mil (25-75 microns). The releasable casting material must either be applied after printing or removed prior to printing.

In accordance with further embodiments, an intermediate extensible adhesive layer such as a high temperature silicone based adhesive and a structural layer, may be provided between the print receptive layer 24 and the primary adhesive 26. The high temperature silicone based adhesive may, for example, be a DENSIL (SA-9000) silicone adhesive sold by FLEXcon Company, Inc. of Spencer, Mass. or a FLEXcon's EXV-495 silicone adhesive sold by FLEXcon Company, Inc. of Spencer, Mass. The structural layer may be a metallic foil such as aluminum foil having a thickness of about 1 mil to about 10 mil, and preferably having a thickness of about 2 mil to about 5 mil. The structural layer may also be formed of a carbon fiber fabric, a fiberglass fabric or a metallic screen material.

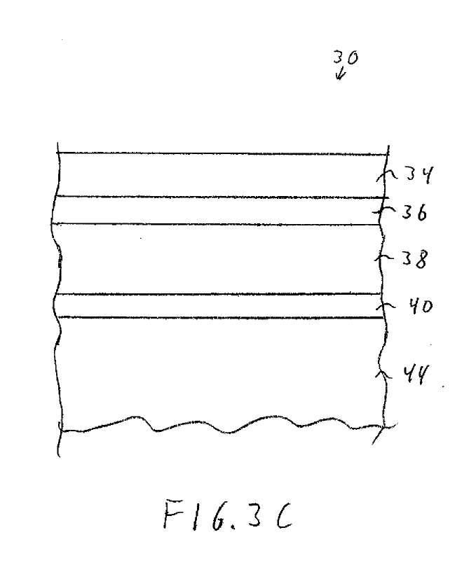

As shown in FIG. 3A, a composite 30 in accordance with a further embodiment of the invention includes a releasable transfer material 32, an printable coating (print receptive layer) 34, a high temperature silicone based adhesive 36 (an intermediate extensible layer), a structural layer 38, a layer of FLEXcon EXA-495 adhesive 40 (a primary adhesive) and a release liner 42. As shown in FIG. 3B, the release liner 42 is then removed from the composite, and the composite is then applied to a surface of a high temperature material 44 via the adhesive layer 40. As shown in FIG. 3C, once the composite is applied to the product, the releasable transfer material 32 may then be removed. As with the embodiment of FIGS. 2A-2C, the releasable transfer material must either be applied after printing or removed prior to printing. The structural layer 38 may be a metallic foil such as aluminum foil having a thickness of about 1 mil to about 10 mil, and preferably having a thickness of about 2 mil to about 5 mil. The structural layer 38 may also be formed of a carbon fiber fabric, a fiberglass fabric or a metallic screen material.

This method of fabrication also permits the use of many other printable materials such as a TiO₂/silicate pigment mix such as used in Example 1, but with substitution of the silicone Silgrip 6573A with a polyimide binder (such as CP1 polyimide resin from Nexolve Corp. Huntsville Ala.).

A difficulty encountered in using a polyimide binder is the lack of flexibility. In a label composite as described above, the printable layer may be provided on an aluminum foil, and the differential thermal expansion characteristics could lead to cracking or lifting of the printable layer. Having the layer of a silicone adhesive EXA-495 for example (or one based on Silgrip 6573A) between the polyimide based binder printable layer and the supporting structural layer of aluminum foil, allows the two layers, to move with some independence. This independent movement between two rigid layers under differential thermal expansion/cooling contraction cycle is beneficial in maintaining a crack free, edge lift free label.

A demonstration of this affect can be found in the following example.

### Example 3

A commercial polyimide based printable coating, CP-1 available from Mantech Nexolve Corporation, 665 Discovery Dr., NW #200, Huntsville, Ala. 35086, was applied directly to a 125 micron (5 mil) aluminum foil, dried and cured in a laboratory oven for three minutes at 100° C., second sample was prepared this time a 25 micron (1 mil) transfer tape of FLEXcon's EXV-495 was applied to the aluminum foil and then the CP-1 coating was applied over the EXV-495, and again dried and cured for three minutes at 100° C.

Both samples were then place in another laboratory oven set at 235° C. oven for 24 hours, after which both were examined. The sample in which the polyimide printable coating was directly applied showed server cracking and peeling. The sample with the EXV-495 between the polyimide printable coating the aluminum foil had only one small crack in only one corner of the sample.

Further it was found that the use of an intermediate extensible coating between a metallic supporting structure and print receptive coating, even when said print receptive coating is one based on silicones, as taught in this disclosure, there is a substantial advantage. In the case where the supporting structure has a high thermal transfer, such as with metallic foils, e.g. aluminum foil, the silicone base print receptive coatings are able to expand and/or contract with the metal foil as it undergoes temperature variations (differential thermal expansion/contraction), thus said coatings do not crack, peel or chip off the metallic foil.

There were however, some unexpected difficulties encountered when the printing on said print receptive coating was attempted with thermal transfer printers such as the Zebra 170xi4 300 dpi printer. What was observed was a failure to get proper imaging, even when using the highest burn setting of 30 and with the slowest speed, 2 ips using an ITW HT 1200 print ribbon or IIMAK SP330 Thermal Transfer Resin print ribbon.

This failure to image is believed to be the result of the high thermal transfer of the aluminum foil, in this example a 100 micron (4 mil). Even the silicone based print receptive coating offered little thermal insulation. It was reasoned that the high percentage of inorganic filler in the silicone based coating allowed heat to be conducted to the aluminum foil and from there the heat dissipated over the entirety aluminum structural backing.

To test this hypothesis a 25 micron (1 mil) layer of EXV-495 (does not contain inorganic filler) was placed between the silicone print receptive coating and the aluminum structural layer, under the same printer settings and print ribbon, clear sharp images were obtained.

Thus the intermediate expandable layer, such as EXV-495, was found to prevent thermal dissipation from occurring in the printing operation.

Further this method of making the label composite also permits ease of fabrication of a label composite, even one based on the silicone binder by affixing, usually with heat and pressure the preformed printable layer employing a variety of structural layer materials. In a similar way, a silicone adhesive applied to the structural layer may also be used to bond to the printable layer on the casting material, to form the same printable layer/structural layer composite.

Another benefit of using the intermediate extensible layer is when the structural layer is something other than a metal foil. The said intermediate extensible layer will form a better bond to the irregular surfaces of structural layers such as fiberglass, carbon fiber fabrics, scrims, and screens. Such open materials have been found to provide paths for outgassing.

It is important to note that the silicones used as the binder material in the printable layer and as the adhesive as the bonding layer for the printable layer and the supporting structural layer, and those used to bond the total composite to the hot surface are on a molecular scale permeable to small molecules such as water vapor and carbon dioxide.

Those skilled in the art will appreciate that numerous modifications and variations may be made to the above disclosed embodiments without departing from the spirit and scope of this invention.

What is claimed is:

1. A label composite comprising:
a print receptive layer that is adapted to withstand temperatures up to 1200° F. (649° C.) without loss of any of readability, cracking, peeling or edge lifting;
an intermediate extensible adhesive layer on one side of the print receptive layer, wherein the intermediate extensible adhesive layer is capable of surviving temperatures up to 1200° F.;
a structural layer adhered on a first side thereof to the intermediate extensible adhesive layer, wherein the structural layer is adapted to withstand temperatures up to 1200° F.; and
a primary adhesive layer capable of surviving temperatures up to 1200° F. and being adapted to form a bond between an elevated temperature material and the structural layer of the label composite.

2. The label composite as claimed in claim 1, wherein said label composite further includes a release liner on the primary adhesive layer.

3. The label composite as claimed in claim 1, wherein said label composite further includes a releasable transfer material that is removable from the label composite after the label composite is adhered to the elevated temperature material.

4. The label composite as claimed in claim 1, wherein the print receptive layer includes a polyamide.

5. The label composite as claimed in claim 1, wherein the print receptive layer includes an inorganic pigment material with a silicone binder, and wherein the inorganic pigment material has a pigment to binder ratio of between about 1/1 and about 4/1.

6. The label composite as claimed in claim 5, wherein the pigment to binder ratio is between about 1.4/1 and about 2/1.

7. The label composite as claimed in claim 5, wherein the inorganic pigment material includes TiO₂ and Silica in a ratio of between 12/1 to 30/1.

8. The label composite as claimed in claim 1, wherein said intermediate extensible adhesive layer includes silicone.

9. The label composite as claimed in claim 1, wherein the intermediate extensible adhesive layer has a thickness of between about 0.5 mil and about 5.0 mil.

10. The label composite as claimed in claim 1, wherein the intermediate extensible adhesive layer has a thickness of between about 1 mil and about 2 mil.

11. The label composite as claimed in claim 1, wherein the structural layer includes a metallic foil.

12. The label composite of claim 11, wherein the metallic foil is aluminum.

13. The label composite as claimed in claim 11, wherein the aluminum foil is between about 0.5 mil-about 20 mil in thickness.

14. The label composite as claimed in claim 13, wherein the aluminum foil is between about 1 mil and about 10 mil in thickness.

15. The label composite as claimed in claim 14, wherein the aluminum foil is between about 2 mil and about 5 mil in thickness.

16. The label composite as claimed in claim 1, wherein the structural material includes carbon fiber fabric.

17. The label composite as claimed in claim 1, wherein the structural material includes a fiberglass fabric.

18. The label composite as claimed in claim 1, wherein the structural material includes a metallic screen.

19. The label composite as claimed in claim 1, wherein the intermediate extensible adhesive layer between the print receptive layer and the structural layer permits some independent movement of the print receptive layer with respect to the structural layer over an operating temperature range of the label composite.

20. A label composite comprising:
a print receptive layer that includes an inorganic pigment material with a silicone binder, wherein the inorganic pigment material has a pigment to binder ration of between about 1/1 and 4/1;
an intermediate extensible adhesive layer on one side of the print receptive layer, wherein the intermediate extensible adhesive layer includes silicone;
a structural layer adhered on a first side thereof to the intermediate extensible adhesive layer; and
a primary adhesive layer being adapted to form a bond between an elevated temperature material and the structural layer of the label composite.

21. A method of providing a label for on an elevated temperature material, said method comprising the steps of:
providing a print receptive layer that is adapted to withstand temperatures up to 1200° F. (649° C.) without loss of any of readability, cracking, peeling or edge lifting on a structural layer that is adhered to the print receptive layer by an intermediate extensible adhesive layer, wherein the intermediate extensible adhesive layer is capable of surviving temperatures up to 1200° F., and wherein the structural layer is adapted to withstand temperatures up to 1200° F.;
adhering the structural layer to an elevated temperature material using a primary adhesive layer that capable of surviving temperatures up to 1200° F. and that is adapted to form a bond between the elevated temperature material and the structural layer; and
permitting the print receptive layer to move with respect to the structural layer over an operating temperature range following application to the elevated temperature composite.

22. The method as claimed in claim 21, wherein said method further includes the step of removing a release liner from the primary adhesive layer.

23. The method as claimed in claim 21, wherein said method further includes the step of removing a releasable transfer material from the print receptive layer following application of the structural layer to the high temperature material.
